(19) United States
(12) Patent Application Publication
(10) Pub. No.: US 2004/0160775 A1
(43) Pub. Date: Aug. 19, 2004

(54) Axially fastened illuminated moisture resistant, standoff fixture

(76) Inventors: Phillip Roe Goodlett, Tustin, CA (US); Steven Phillip Arendt, Newport Beach, CA (US)

Correspondence Address: GENE SCOTT; PATENT LAW & VENTURE GROUP, 3140 RED HILL AVENUE, SUITE 150, COSTA MESA, CA, 92626-3440, US

(21) Appl. No.: 10/783,755

(22) Filed: Feb. 20, 2004

Related U.S. Application Data
(63) Continuation-in-part of application No. 10/117,242, filed on Apr. 5, 2002.

(51) Int. Cl. F21V 33/00; B65H 16/06

(52) U.S. Cl. 362/253; 242/598.5

(57) ABSTRACT

An illuminated rod standoff has a base with a recessed surface mountable to a wall, and an axially positioned fastener oriented normal to the recessed surface. The fastener engages a cap which centers a cylindrical sidewall resting on the recessed surface within a close-fitting peripheral edge. The cap closes an open distal end of the sidewall and provides a fastener holding the cap securely to the cylindrical sidewall and the cylindrical sidewall to the base. A towel or tissue rod my be engaged with the cap. A pair of lamps are mounted on the base for transmitting light through the cylindrical sidewall in a highly uniform manner.

### RELATED APPLICATIONS

This application is a Continuation In Part Application of a prior filed application having Ser. No. 10/117,242 and filing date of Apr. 5, 2002 and entitled: Axially Fastened Illuminated Fixture Standoffs.

### BACKGROUND OF THE INVENTION

1. Field of the Invention

This invention relates generally to bathroom fixtures and more particularly to such fixtures having lighting features.

2. Description of Related Art

The following art defines the present state of this field:

Murphy, U.S. Des. 381,734 describes a submersible fish attracting light design.

Larson et al., U.S. Pat. No. 2,217,688 describes a combination of spaced wall brackets adapted to be secured to a side wall of a vehicle, a baggage rack unit, means for removably supporting the unit on the brackets, each of the brackets being in the form of a box housing, extending throughout substantially the entire width of the rack unit and being of relatively deep cross section and supported from the wall at vertically spaced points to make the brackets cantilevers of sufficient strength to carry the baggage rack load, a source of light within each bracket, the major portion of the bottom wall of the housing being light transmitting.

Woolley, U.S. Pat. No. 2,827,555 describes a combination lighting and rail fixture for clothes closets and the like, comprising an elongate frame having front and rear portions and means at its ends adjoining said rear portion for attaching it to a support; and glass envelope carried by the frame at its ends and extending substantially coextensive therewith; and elongate, opaque shade having a substantially U-shaped cross section, said shade extending substantially coextensive with and partially enclosing said light-producing means and being arranged to block some of the light therefrom; and a garment rail having a relative large surface per unit length, connected with the frame and extending substantially coextensive therewith, said rail being spaced from and located below the said light-producing means and being located wholly below said frame and accessible in a horizontal direction from the front of the fixture said rail having a diameter commensurate with the diameter of the said tubular glass envelope, and being adapted to receive and support garment hangers by which light colored garments hung thereon may reflect light from the light-producing means upward.

Nestrock, U.S. Pat. No. 4,569,689 describes a grab bar or handrail system that not only incorporates its own spaced directional illumination sources but also its complete electrical cabling. Thus, installation of the system requires virtually no special electrical cabling or conduit within the wall, such ducting being limited to that required for a single end connection, or to bridge a discontinuity in the handrail, as where the wall is interrupted for a doorway, window, or the like opening. Illumination sources are provided within and as part of each supporting bracket, and individual electrical connection thereof to the supply cabling is made adjacent each support and within the grab bar. Provision is made for automatic transfer from house voltage supply to standby storage supply, in the event of power failure, thus assuring the maximum safety that constant illumination can provide.

Wojski, U.S. Pat. No. 5,412,553 describes a lighted curtain hardware assembly for a wall having an opening therein having a curtain support hardware device. The hardware device is mountable adjacent the opening, such as a window or door, for supporting a curtain in front of and adjacent the opening without visually obstructing the opening. The hardware device has a light mounted thereon. Electrical means are included for providing electricity to the light to provide an attractive lighted decoration to the window or door and adjacent wall.

Hixon, U.S. Pat. No. 5,624,024 describes a multipurpose toilet tissue dispenser comprising: a housing having a front wall and including means for holding a roll of toilet paper; means for holding a night light assembly; a pencil holder; and means for holding an air freshener, the apparatus further including means for attaching the housing to a bathroom wall, the means for holding a roll of toilet paper including a generally semi-cylindrical shaped recess positioned in the front wall and a spindle for holding a roll of toilet paper, the spindle being releasably coupled within the recess, the spindle holding and permitting rotatable dispensing of toilet tissue when desired by a user.

McCall, Jr., U.S. Pat. No. 6,00,658 describes a toilet paper dispenser in which a roll of toilet paper is supported on a rotatable spindle with a music box activated by rotation of the spindle. The toilet paper dispenser is equipped with an aromatic fragrance dispenser which is automatically activated by rotation of the spindle.

Von Schenk, U.S. Pat. No. 6,056,233 describes a cover system for toilet paper to protect the toilet paper from dispersal by children and pets comprising a wall-mounted plastic casing completely covering upper and lower rolls of paper. The upper and lower rolls are covered by respective upper and lower swivelable covers, each having a safety latch system. Each safety latch system includes a pair of button-releasable latches with one button on each side of the casing and each cover may be released only by pushing both such buttons at the same time. The covers are light permeable and night lights may be mounted to the inside of the casing or as part of each holder going through each toilet paper roll.

Schroder, EP 0851170 A1 describes a curtain rod in the form of a tube in holders. In at least one end of the rod, or elsewhere within the rod, there is a holder for a bulb or other light. A lead runs from the bulb holder to the outside of the rod. The holder may be externally threaded to fit into an internal thread in the rod end. The bulb holder may have a connection device, from which a lead passes through a slit in the wall of the tubular rod. It may be possible to screw a lampshade onto the external thread of the bulb holder.

The prior art teaches illumination in a curtain rod, tissue rod, grab bar, fish attracting bar, and in an assembly for supporting a tissue roll. The prior art also teaches illumination of filials on a curtain rod, in a closet fixture and mounted on an undersurface of standoffs for holding a luggage rack. However, the prior art fails to teach illumination means mounted within a structural standoff for bathroom fixtures. This is most likely because the structural standoff typically is not robust enough to be made of glass or other transparent material. However, the present invention is a solution to this need providing illumination and structural strength in a standoff that requires only a single fastener to assemble and apply moisture eliminating compressive forces. This fulfills the needs described and provides further related advantages as further described in the following summary.

### SUMMARY OF THE INVENTION

The present invention teaches certain benefits in construction and use which give rise to the objectives described below.

An illuminated standoff has a base with a recessed surface mountable to a wall, and an axially positioned stud oriented normal to the recessed surface. The stud engages a cap which centers a transparent cylindrical sidewall resting on the recessed surface within a close-fitting peripheral edge. The cap closes an open end of the sidewall an may provide a rod receiver. A single screw applies compressive forces directly between the cap, sidewall and base elements. Dual lamps are mounted normally on the base for transmitting light through the cylindrical sidewall for illuminating a space or for decorative purposes. Clearly, the prior art teaches the use of illumination in conjunction with utility items such as curtain rods and bathroom fixtures. The usefulness of such items is well regarded. The benefit of placing illumination within the standoffs for a bathroom fixture such as a towel rod or toilet paper roll rod is that the electrical components of an illumination circuit are secure from rough handling and from moisture.

A primary objective of the present invention is to provide an apparatus and method of use of such apparatus that provides advantages not taught by the prior art.

Another objective is to provide such an invention capable of illumination of one or more wall mounted standoffs for supporting a robe or a towel or tissue roll rod.

A further objective is to provide such an invention capable of being assembled with a single axially oriented fastener.

A still further objective is to provide such an invention capable of illuminating wall mounted standoffs uniformly around a circular sidewall.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the present invention. In such drawings:

FIG. 1 is a perspective exploded view of the preferred embodiment of the invention;

FIG. 2 is a perspective view thereof as assembled, and

FIG. 3 is a cross-sectional view thereof taken along line 3-3 in FIG. 2.

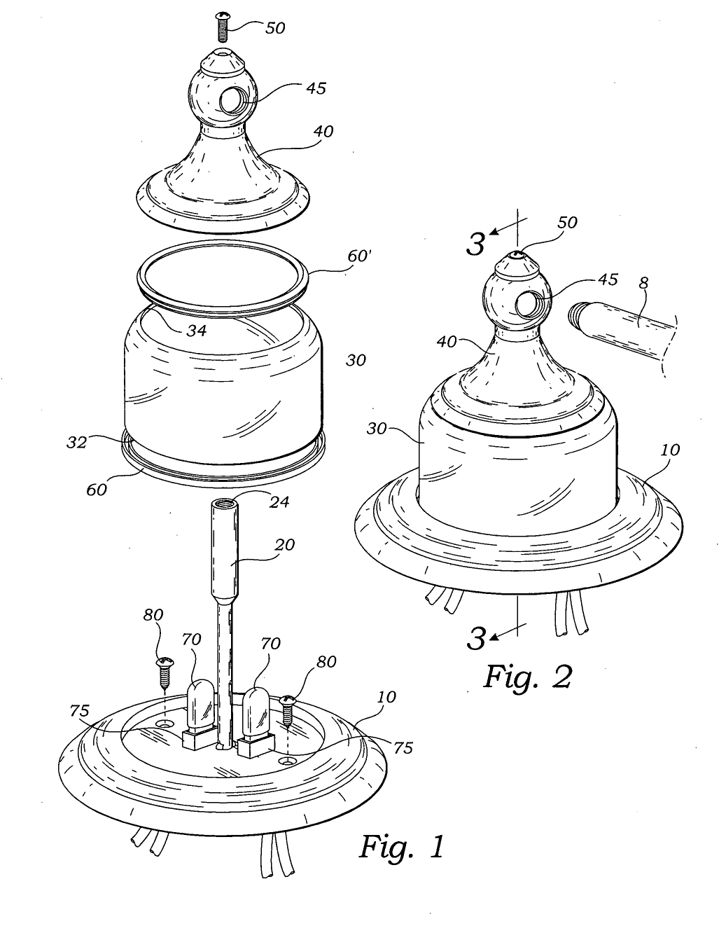

### DETAILED DESCRIPTION OF THE INVENTION

The above described drawing figures illustrate the invention in at least one of its preferred embodiments, which is further defined in detail in the following description. Those having ordinary skill in the art may be able to make alterations and modifications in the present invention without departing from its spirit and scope. Therefore, it must be understood that the illustrated embodiments have been set forth only for the purposes of example and that they should not be taken as limiting the invention as defined in the following.

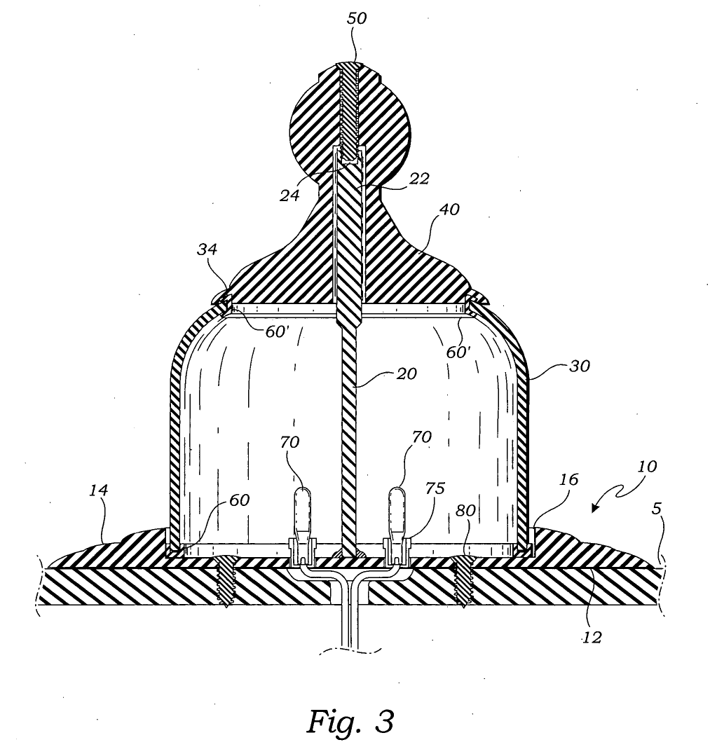

The present invention is an illuminated standoff apparatus having a base 10 with a planar surface 12 ideal for abutting a flat wall surface 5, such as an interior wall surface in a rest-room, toilet or bathroom. The base 10 further provides a decorative surface 14 in opposition to the planar surface 12, and this decorative surface 14 is visible when the base 10 is mounted on the wall surface 5, as best shown in FIG. 3. The base 10 preferably provides a recess 16 in the decorative surface 14. Fixed within the recess 16, preferably centered therein, is an elongated stud 20 axially oriented normal to the planar surface 12 and extending outwardly from the recess 16. The stud 20 provides, at its free end 22, a first means for attachment 24, preferably, an axially oriented threaded hole.

A light transmissive cylindrical sidewall 30, preferably made of a glass or plastic material, is open at its opposing ends, defining first 32 and second 34 peripheral lips, as shown in FIG. 3. The first peripheral lip 32 is engaged with the base 10 within the recess 16, the base 10 thereby closing the sidewall 30 at its proximal end. A cap 40 is engaged with the second peripheral lip 34, the cap 40 thereby closing the sidewall 30 at its distal end; the sidewall 30 thus being fully enclosed.

The cap 40 is configured so as to receive either a garment, i.e., acting as a robe hook, a towel rod for hanging towels, or a toilet paper roll rod for mounting such paper rolls. When configured for towels or paper rolls, the cap 40 has a receiver 45 as shown in FIG. 2 for accepting rod 8. The cap 40 provides an axially oriented through clearance hole 42 as shown in FIG. 3. A second means for attachment 50, preferably a machine screw or equivalent removable fastener, is fitted in the hole 42 and engages the first attachment means 24 of stud 20 so as to be able to apply an axial compressive force between cap 40, sidewall 30 and base 10. Preferably, seals 60 and 60′ are applied to peripheral lips 32 and 34, respectively, so as to enable the apparatus to exclude moisture from the interior of sidewall 30. Alternatively, the cap 40 may be fitted with a set screw for mounting the cap by tightening the set screw against the stud. This arrangement is shown in the incorporated references.

As stated in the summary above, an important objective of the present invention is to produce an even lighting effect at all points on the light transmissive enclosure sidewall 30. Although a non-round enclosure is possible, i.e., a square or other multi-sided cylinder, in practice, the sidewall is preferable round as shown in the figures, as a round enclosure is more easily evenly illuminated. Therefore, for a round enclosure, by geometry it is seen that when the light source is placed at the center of the enclosure, the light falling onto the enclosure is uniform at all points. However, since in the present case it is not possible to have the source of light occupy the center of the enclosure because the stud 20 occupies the center, the source of light must be positioned to one side of the stud 20. However, when that is the case, the stud blocks some of the light and casts a shadow onto the enclosure in the opposite direction from the source of light. To overcome this drawback, the present invention provides two equally bright sources of light, and these are placed on opposing sides of the stud, and as close to the stud as possible. It may be shown that ideal placement of the two light sources is, again, at the center of the enclosure. However, since that is not possible, the sources are minimally displaced from the center, and on opposing sides of the stud on a common diameter of the circular enclosure. The stud 20 presets a shadow effect to each of the light sources onto the sidewall, but when the rod is minimized in its diameter, such shadowing effect is minimized and may be unobvious. The stud 20 is formed with a smaller diameter along its length where it passes the lamps so as to minimize the shadowing effect. The light sources are preferably a pair of lamps 70 engaged in the recess 16 and extending outwardly therefrom, preferably, with the lamps oriented normal to the planar surface 12 of the base 10. The lamps 70 are preferably mounted on opposite sides of the stud 20 and as close as possible thereto. It has been found that a highly uniform illumination of the sidewall 30 is thus achieved.

Preferably the lamps 70 are of the press-in type such as part number WB1210XF from Bulb Manufacturing, Inc.; and are press-fit mounted into sockets 75 such as part number D2600 from American De Rosa, Inc., secured in the base 10 as shown. Electrical wires from the sockets extend from the base and are fitted to a common utility panel which is not shown. Screws 80 are used to mount the base 10 on the wall surface 5, as shown in FIG. 3.

The enablements described in detail above are considered novel over the prior art of record and are considered critical to the operation of the instant invention and to the achievement of the above described objectives. The words used in this specification to describe the invention and its various embodiments are to be understood not only in the sense of their commonly defined meanings, but to include by special definition in this specification: structure, material or acts beyond the scope of the commonly defined meanings. Thus if an element can be understood in the context of this specification as including more than one meaning, then its use must be understood as being generic to all possible meanings supported by the specification and by the word or words describing the element.

The definitions of the words or elements of this described invention and its various embodiments are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the invention and its various embodiments or that a single element may be substituted for two or more elements in a claim.

Changes from the claimed subject matter as viewed by a person with ordinary skill in the art, now known or later devised, are expressly contemplated as being equivalents within the scope of the invention and its various embodiments. Therefore, obvious substitutions now or later known to one with ordinary skill in the art are defined to be within the scope of the defined elements. The invention and its various embodiments are thus to be understood to include what is specifically illustrated and described above, what is conceptually equivalent, what can be obviously substituted, and also what essentially incorporates the essential idea of the invention.

While the invention has been described with reference to at least one preferred embodiment, it is to be clearly understood by those skilled in the art that the invention is not limited thereto. Rather, the scope of the invention is to be interpreted only in conjunction with the appended claims and it is made clear, here, that the inventor(s) believe that the claimed subject matter is the invention.

What is claimed is:

1. An illuminated standoff apparatus comprising: a base providing a planar portion, the planar portion configured for abutting and mounting onto a wall surface; an elongated stud fixed to the planar portion and extending axially outwardly therefrom, the stud providing, at a free end thereof, a first means for attachment; a pair of lamps engaged in the base and extending outwardly therefrom, the lamps mounted in opposing positions on opposite sides of the stud and proximate thereto; a light transmissive cylindrical sidewall having opposing first and second peripheral lips, the first peripheral lip engaged with the base, the base thereby closing a first end of the cylindrical sidewall; a cap engaged with the second peripheral lip thereby closing a second end of the cylindrical sidewall, the cap providing a means for receiving one of a garment, a towel rod and a toilet paper roll rod; a second means for attachment extending axially through the cap and removably engaged with the first means for attachment; the second means for attachment enabled for applying compressive abutment between the cap and cylindrical sidewall, and further between the cylindrical sidewall and the base.

2. The apparatus of claim 1 wherein the first and second means for attachment are threadably engaged.

3. The apparatus of claim 1 wherein the cylindrical sidewall is one of transparent and translucent.

4. The apparatus of claim 1 wherein a moisture excluding means is fitted between at least one of: the cap and the cylindrical sidewall and the cylindrical sidewall and the base.

5. The apparatus of claim 1 wherein the two lamps are positioned for optimal circumferential uniformity of light at the cylindrical sidewall.

6. The apparatus of claim 5 wherein the lamps are positioned proximate the stud and on opposing sides thereof.

7. The apparatus of claim 6 wherein the stud is of a minimal diameter for expressing a minimal shadowing effect on the sidewall.

8. An illuminated standoff apparatus comprising: a base for abutting and mounting onto a wall surface; engaged with the base and extending outwardly therefrom in a normal attitude to the wall surface when the base is mounted thereon: an elongated stud and a pair of lamps, the lamps mounted on opposite sides of the elongated stud and in closest proximate thereto; a light transmissive cylindrical sidewall having opposing first and second open ends, one of the open ends engaged with and closed by the base, the other of the open ends engaged with and closed by a cap, the cap providing a means for receiving at least one of: a garment, a towel rod and a toilet paper roll rod; and a means for attachment of the cap to the stud.

9. The apparatus of claim 8 wherein the means for attachment is threadably engaged.

10. The apparatus of claim 8 wherein the cylindrical sidewall is one of transparent and translucent.

11. The apparatus of claim 8 wherein a moisture excluding means is fitted between at least one of: the cap and the cylindrical sidewall and the cylindrical sidewall and the base.

12. The apparatus of claim 8 wherein the two lamps are positioned for optimal uniformity of illumination on the cylindrical sidewall.

13. The apparatus of claim 8 wherein the stud is of a diameter for expressing a minimal shadowing effect on the sidewall.
